(19) United States
(12) Patent Application Publication
(10) Pub. No.: US 2025/0156232 A1
(43) Pub. Date: May 15, 2025

(54) COMPUTER SYSTEM AND METHOD FOR APPLICATION COMPATIBLE EXECUTION

(71) Applicant: Shanghai Zhaoxin Semiconductor Co., Ltd., Shanghai (CN)

(72) Inventors: Weilin WANG, Beijing (CN); Yingbing GUAN, Shanghai (CN)

(21) Appl. No.: 18/733,275

(22) Filed: Jun. 4, 2024

(30) Foreign Application Priority Data
Nov. 10, 2023 (CN) 202311500090.6

(51) Int. Cl. G06F 9/50; G06F 9/48

(52) U.S. Cl. CPC G06F 9/5044; G06F 9/4856

(57) ABSTRACT

A computer system with a hybrid architecture processor that provides both first-type and second-type cores is shown. In response to execution of an application, an operating system running on the hybrid architecture processor evaluates core-change indicators corresponding to the application, to change the core executing the application from the first-type core to the second-type core, or vice versa, based on the core-change indicators, to continue execution of the application.

### CROSS REFERENCE TO RELATED APPLICATIONS

This application claims priority of China Patent Application No. 202311500090.6, filed on Nov. 10, 2023, the entirety of which is incorporated by reference herein.

### BACKGROUND OF THE DISCLOSURE

### Field of the Disclosure

The present disclosure relates to a hybrid architecture processor of a computer system, and in particular to application compatibility on a hybrid architecture processor.

### Description of the Related Art

With the booming development of computing technology, hybrid architecture processors have been proposed as a means of balancing between performance and power consumption. A hybrid architecture processor contains at least two types of cores, and each type of core may support different instructions (for example, one type of core may support a complete set of instructions, while another type of core may support partial instructions). Thus, it is hard to schedule an application process on a hybrid architecture processor. In order to reduce the difficulty of application process scheduling, the existing technology may downgrade the bigger core, which supports more instructions, to a smaller core, to use only a part of the instructions of the bigger core. This is a waste of computing resources. How to fully utilize the resources of each core in a hybrid architecture processor is one of the problems to be solved by those skilled in the art.

### BRIEF SUMMARY OF THE DISCLOSURE

This case proposes a computer system and a method for application compatible execution.

A computer system in accordance with an exemplary embodiment of the disclosure includes a hybrid architecture processor that includes a first-type core and a second-type core. In response to execution of an application, an operating system running on the hybrid architecture processor evaluates core-change indicators corresponding to the application, to change the core executing the application from the first-type core to the second-type core, or vice versa, based on the core-change indicators.

In another exemplary embodiment, a method for application compatible execution is shown, which includes the following steps. The method includes providing a hybrid architecture processor that includes a first-type core and a second-type core. In response to execution of an application, the method includes using an operating system running on the hybrid architecture processor to evaluate core-change indicators corresponding to the application, to change the core executing the application from the first-type core to the second-type core, or vice versa, based on the core-change indicators.

Through the computer system and the method proposed in this paper, the operating system first evaluates the core-change indicators of the application, and then switches between the first-type core and the second-type core, according to the core-change indicators, to continue execution of the application. Thus, resources of the different cores are utilized well.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates a computer system 100 in accordance with an exemplary embodiment of the disclosure, which includes a hybrid architecture processor 102 that has a first-type core 106_# and a second-type core 108_#;

FIG. 2 illustrates a core 200 in accordance with an exemplary embodiment of the disclosure;

FIG. 3 illustrates a design of the model-specific registers MSRcntr in the core 200 in accordance with an exemplary embodiment of the disclosure, which include model-specific registers (MSRs) 302, 304, 306, and 308;

FIG. 4 illustrates a dynamic update manner of the core-change indicators in accordance with another exemplary embodiment of the disclosure, which is described with respect to the core-change indicators MEMcntr stored in the system memory 104 of FIG. 1;

FIG. 5A and FIG. 5B are flow charts illustrating the operations of the operating system in accordance with an exemplary embodiment of the disclosure; and

FIG. 6 is a flow chart illustrating how the operating system adaptively assigns an application process to a proper core based on a translation count of the application.

### DETAILED DESCRIPTION OF THE DISCLOSURE

The following description enumerates various embodiments of the disclosure, but is not intended to be limited thereto. The actual scope of the disclosure should be defined according to the claims. The various blocks/modules mentioned below may be implemented by a combination of hardware, software, and firmware, and may also be implemented by special circuits. The various blocks/modules are not limited to being implemented separately, but can also be combined together to share certain functions. In this paper, the descriptions “execute (or run) an application process” and “execute (or run) an application” have the same meaning.

As various computer applications flourish, improved processor architectures are developed. Some legacy instructions supported by the legacy architecture may not be needed in certain applications. Compared with the legacy architecture, a simplified architecture (with simplified hardware) may support fewer legacy instructions.

However, applications on the market are generally designed for the legacy architecture, and are hereinafter referred to as legacy applications. Legacy applications may use legacy instructions that the core in simplified architecture cannot handle. The solution proposed in this paper is to design a hybrid architecture processor that not only provides a small core with a simplified architecture, but also provides a big core with a legacy architecture. The small core includes a translator. By translating legacy instructions, the small core can still execute legacy applications although in an inefficient way. In particular, this disclosure also provides a core change mechanism that is adaptive to each application. In response to detecting the aforementioned inefficient operations, the operating system schedules the big core to take over running this legacy application and thereby the execution efficiency of the legacy application is improved. In such a hybrid architecture processor, legacy applications can also run efficiently.

Similar application compatibility issues may also occur in new generation architectures developed due to the technological evolution. Legacy applications may use legacy instructions that the new generation architecture processors cannot handle (e.g., undefined instructions, or instructions with changed semantics). The hybrid architecture processor of the disclosure not only provides a core of the new generation architecture (also known as the new generation core), but also provides a core of the legacy architecture (also known as the legacy core). The new generation core may include a translator for execution of legacy applications, but the performance may be bad. Through the disclosed core change mechanism adaptive to the each application, the inefficient execution is detected and the operating system schedules the legacy core to take over running the legacy application. Thus, the system performance is improved, and full utilization of the resources of the legacy core is achieved.

In an exemplary embodiment, the hybrid architecture processor disclosed in this disclosure includes a first-type core and a second-type core. The first-type core may be a small core and the second-type core may be a big core. Alternatively, the first-type core may be a new generation core and the second-type core may be a legacy core. Specifically, the proposed hybrid architecture processor is not limited to include small core and big core, or include new generation core and legacy core. Any hybrid architecture processor using at least two types of cores with a core change mechanism adaptive to the each application should be considered as involving the concept of the disclosure.

In an exemplary embodiment, the first-type core (such as the aforementioned small core/new generation core) uses a translator. The core change is based on a translation count of the first-type core. The more frequent instruction translations means that the current application is not suitable for running on the first-type core, and the operating system schedules the second-type core to take over running the application.

In an exemplary embodiment, the core change is not based on the translation count, but is based on an instruction retiring density or energy consumption. If the instruction retiring density is too low, or the energy consumption is too high, it is changed to the second-type core to run the application.

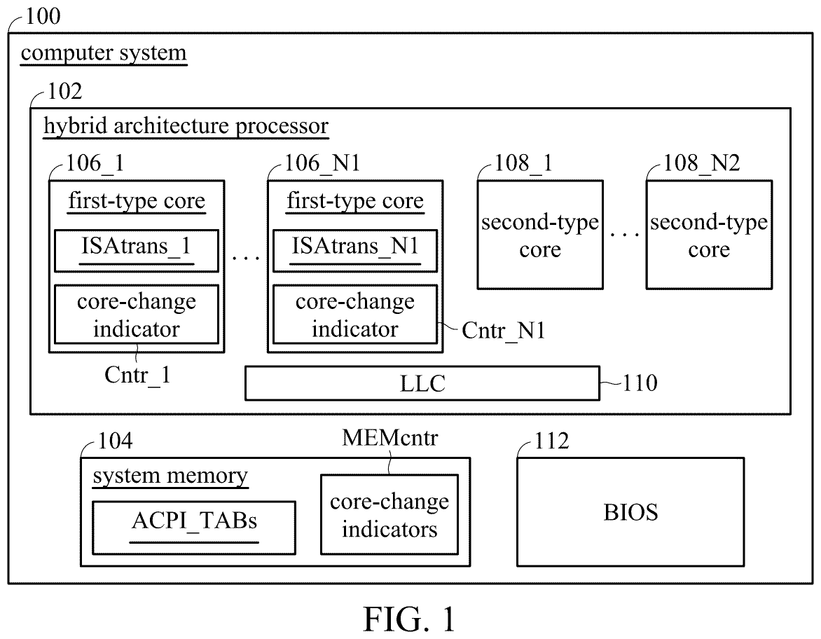

FIG. 1 illustrates a computer system 100 in accordance with an exemplary embodiment of the disclosure, which includes a hybrid architecture processor 102 and a system memory 104 coupled to the hybrid architecture processor 102. The hybrid architecture processor 102 includes at least one first-type core (106_1 . . . 106_N1, hereinafter referred to as 106_#), and at least one second-type core (108_1 . . . 108_N2, hereinafter referred to as 108_#). The hybrid architecture processor 102 further includes a last level cache (LLC) 110, which is shared by the cores 106_1 . . . 106_N1 and 108_1 . . . 108_N2. In an exemplary embodiment, the cores 106_1 . . . 106_N1 and 108_1 . . . 108_N2 each is a logical core.

The hardware of the first-type core 106_# is simpler than that of the second-type core 108_#. In an exemplary embodiment, the first-type core 106_# is the aforementioned small core, and the second-type core 108_# is the aforementioned big core. In another exemplary embodiment, the first-type core 106_# is the aforementioned new generation core, and the second-type core 108_# is the aforementioned legacy core.

In the illustrated example, each first-type core 106_# includes a translator (ISAtrans_1 . . . ISAtrans_N1, hereafter referred to as ISAtrans_#). For special instructions that are supported by the second-type core 108_# but not supported (or semantically changed) on the first-type core 106_#, the translator ISAtrans_# translates them into a simulation program. This simulation program may be composed of macro instructions or micro instructions. Each instruction of the simulation program is natively supported by the first-type core 106_#. The first-type core 106_# completes execution of a special instruction by executing its corresponding simulation program.

Regarding core change, the first-type cores 106_# may evaluate core-change indicators Cntr_#(referring to Cntr_1 . . . Cntr_N1 in the different cores 106_1 . . . 106_N1) for their running applications to decide whether to schedule a second-type cores 108_# to take over any of the applications. Other implementations may store the core-change indicators Cntr_1 . . . Cntr_N1 in the system memory 104, referring to the label MEMentr in the figure. The core-change indicators Cntr_# may be the implemented as the aforementioned translation count, or/and instruction retiring density, or/and energy consumption.

The following shows how to adaptively change from the first-type core 106_# to the second-type core 108_# according to information collected for the running application. After being powered on or reset, the computer system 100 runs a basic input output system (BIOS) 112 to create an Advanced Configuration and Power Interface table (ACPI table) for each core. In the ACPI table, one bit (a reserved bit or a newly added bit) is used in identification of the first-type cores 106_# and the second-type cores 108_#. The BIOS 112 may store the ACPI tables to the system memory 104 (ACPI_TABs in the figure). Based on the information obtained from the ACPI tables ACPI_TABs, the operating system switches to the proper core to continue the execution of the target application. In an exemplary embodiment, the BIOS learns that each core is the first-type core 106_# or the second-type core by executing a CPU identification (CPUID) instruction on each core. In another exemplary embodiment, by executing the CPUID instruction, the BIOS further learns whether a first-type core 106_# has a translator ISAtrans_#.

The special instructions translated on the first-type core 106_# may be classified into two kinds. The first kind of special instructions are supported by the second-type core 108_#, but not supported by the first-type core 106_#(i.e., undefined in the first-type core 106_#). The second kind of special instructions are supported by the first-type cores 106_# as well as the second-type cores 108_# in a semantic-changed manner. When a legacy application is run by the first-type core 106_#, the first kind of special instructions may cause an undefined instruction exception #UD, and the second kind of special instructions may cause a general purpose exception #GP. However, except for the first kind of special instructions only defined in the second-type core 108_#, some other instructions not defined in the first-type core 106_# may also cause the undefined instruction exception #UD. In an exemplary embodiment, an undefined instruction exception handler (#UD exception handler) is proposed, to determine whether the undefined instruction exception #UD is caused by the first kind of special instructions, to perform instruction translation or not. Similarly, except for the second kind of special instructions (semantic changed instructions), the first-type core 106_# may have other semantic protection designs that will cause the general purpose exception #GP. In an exemplary embodiment, a general purpose exception handler (#GP exception handler) is proposed, to determine whether the general purpose exception #GP is caused by the second kind of special instruction, to perform instruction translation or not.

In an exemplary embodiment, the undefined instruction exception handler executed in response to an undefined instruction exception #UD looks up a table to identify the exception #UD and, based on the identified result, the undefined instruction exception handler decides whether to perform instruction translation or not. For example, the undefined instruction exception handler may use a special instruction table to list the operation codes (opcodes) used in the first kind of special instructions not supported by the first-type core 106_#. If any opcode of a target instruction causing the undefined instruction exception #UD is listed in the special instruction list (hit), the undefined instruction exception handler determines that the target instruction is designed to be executed by the second-type core 108_# rather than the first-type core 106_#. Translation on the first-type core 106_# is required.

In an exemplary embodiment, the general purpose exception handler executed in response to a general purpose exception #GP looks up a table to identify the exception #GP and, based on the identified result, the general purpose exception handler decides whether to perform instruction translation or not. For example, the general purpose exception handler may use a special instruction table to list the operation codes (opcodes) used in the second kind of special instructions (with changed semantics in the first-type core 106_#). If any opcode of a target instruction causing the general purpose exception #GP is listed in the special instruction list (hit), the general purpose exception handler also checks an error code of the general purpose exception #GP, to determine whether the target instruction is more suitable to the second-type core 108_#. In another exemplary embodiment, when determining that the target instruction causing the general purpose exception #GP has any opcode listed in the special instruction list (hit), the general purpose exception handler also checks the error code of the general purpose exception #GP as well as a source operand (src) of the target instruction, to determine whether the target instruction is more suitable to the second-type core 108_#.

The following uses I/O instructions as an example to explain in detail how to determine whether a target instruction causing the general purpose exception #GP is one of the special instructions. When the first-type core 106_# executes an I/O instruction causing a general purpose exception #GP, the error code of the general purpose exception #GP is pushed into a stack, and a general purpose exception handler is triggered. According to the general purpose exception handler, the error code of the general purpose exception #GP is read from the stack to determine whether the error code is a predetermined value (for example, 0). If the error code of the general purpose exception #GP is not a predetermined value, it means that the I/O instruction is not a special instruction monitored in the disclosure. If the error code of the general purpose exception #GP is the predetermined value, it is further checked whether any opcode of the I/O instruction is listed in the special instruction list. If not (miss), it means that the I/O instruction is not a special instruction monitored in the disclosure. If the opcode of the I/O instruction is listed in the special instruction list (hit), it means that the I/O instruction is a special instruction monitored in the disclosure.

The following uses jump instructions (such as JMP, JE, JNE, JZ, JNZ, etc.) as an example to explain in detail how to determine whether a target instruction causing the general purpose exception #GP is a special instruction monitored in the disclosure. When the first-type core 106_# executes a jump instruction causing a general purpose exception #GP, the error code of the general purpose exception #GP is pushed into a stack, and a general purpose exception handler is triggered. According to the general purpose exception handler, it is checked whether any opcode of the jump instruction is listed in the special instruction list. If not (miss), it means that the jump instruction is not the special instruction monitored in the disclosure. If any opcode of the jump instruction is listed in the special instruction list (hit), the general purpose exception handler reads the error code of the general purpose exception #GP from the stack. Then the general purpose exception handler uses the source operand of the target instruction as a base address, and uses the error code of the general purpose exception #GP as a segment selector to search a segment descriptor table to find a matched segment descriptor. If there is no matched content in the segment descriptor table, it means that the jump instruction is a special instruction suitable to the second-type core 108_#. If a matched segment descriptor is obtained, based on the properties of the obtained segment descriptor, it is determined whether the obtained segment descriptor is supported by the first-type core 106_#. If the obtained segment descriptor is supported by the first-type core 106_#, it means that the jump instruction is not a special instruction suitable for execution on the second-type core 108_#. If the obtained segment descriptor is not supported by the first-type core 106_#, it means that this jump instruction is a special instruction suitable for execution on the second-type core 108_#. In an exemplary embodiment, the first-type core 106_# only supports 64-bit segment descriptors, but the obtained segment descriptor is a 16-bit or 32-bit descriptor. Thus, it is determined that the obtained segment descriptor is not supported by the first-type core 106_#. In an exemplary embodiment, the source operand of the target instruction is also stored in the stack before execution of the general purpose exception handler. The source operand of the target instruction is retrieved from the stack when the general purpose exception handler is executed.

In an exemplary embodiment, the general purpose exception #GP is represented by an exception code, and the exception code is pushed into the stack. Based on the stacked exception code, the general-purpose exception handler, executed in response to the general-purpose exception #GP, determines whether the target instruction causing the general-purpose exception #GP is a special instruction suitable for execution on the second-type core 108_#. In an exemplary embodiment, when the exception code of the general purpose exception #GP is a specific value other than 0 (for example, 50 or 51), it means that the target instruction causing the general purpose exception #GP is a special instruction suitable for execution on the second-type core 108_#.

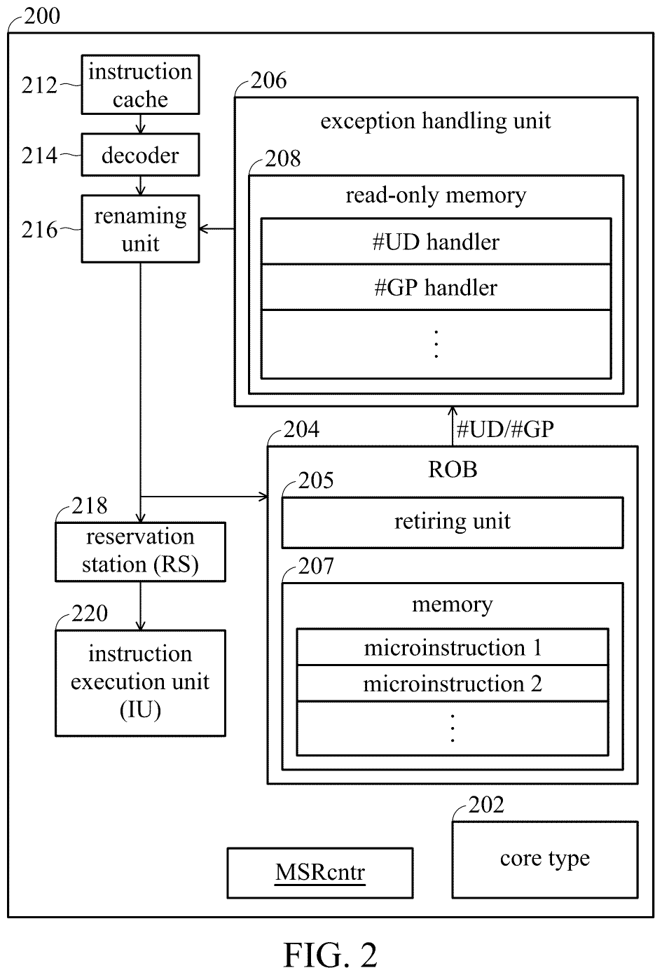

FIG. 2 illustrates a core 200 in accordance with an exemplary embodiment of the disclosure. To be used in the proposed hybrid architecture processor, the core 200 may have a model-specific register (MSR) to fill in the core type 202 to mark itself as a first-type core 106_# or a second-type core 108_#. The core 200 further uses model-specific registers MSRcntr for dynamically update of core-change indicators (such as translation count, or/and instruction retiring density, or/and energy consumption) of the running application. The core-change indicator may be directly filled in the model-specific registers MSRcntr. Alternatively, the model-specific registers MSRentr store an address pointing to the core-change indicators MEMcntr dynamically updated on the system memory 104.

This paragraph takes the first-type core 106_# as an example. The first-type core 106_# executes an application. If an undefined instruction exception #UD or a general purpose exception #GP occurs and is buffered in the reorder buffer (ROB) 204, an exception handling unit 206 traps to the corresponding exception handler (wherein the code of the undefined instruction exception handler and the general purpose exception handler is stored in a read-only memory 208). According to the exception handler, it is determined whether the target instruction causing the undefined instruction exception #UD or the general purpose exception #GP is a special instruction monitored in the disclosure. In response to the identified special instruction, instruction translation is performed by the first-type core (200).

This paragraph details operations of the core 200. An instruction cache 212 caches instructions (which are macro instructions) retrieved from the system memory 104. The decoder 214 decodes the instructions obtained from the instruction cache 212, to generate microinstruction(s). For example, each macro instruction may be decoded to at least one microinstruction. In the illustrated example, a macro instruction is decoded to microinstructions 1 and 2, which are renamed by a renaming unit 216 (e.g., physical registers are allocated to the microinstructions) and sends to a reservation station (RS) 218 as well as the reorder buffer 204 in their coding order. The reservation station 218 receives and saves the microinstructions from the renaming unit 216. When the microinstructions meet the execution conditions, the microinstructions are sent to an instruction execution unit (IU) 220 (wherein the microinstructions may not be sent to the instruction execution unit 220 in their program order). The instruction execution unit 220 executes the microinstruction received from the reservation station 218, writes the execution results (including normal execution results and abnormal results) into the entries, corresponding to the microinstructions, in a memory 207, and marks them as completed execution. The reorder buffer 204 writes the microinstructions received from the renaming unit 216 into the memory 207 in their program order. A retiring unit 205 determines whether the oldest microinstruction (the oldest uncommitted microinstruction) in the memory 207 satisfies the retiring condition. If yes, the oldest microinstruction is retired. If the target to be retired is irrelevant to any exception, the retiring is performed in a normal manner (such as updating the architectural registers, deleting the corresponding microinstruction from the memory 207, etc.). As for a retiring target with an exception, the related message (including information of the exception) is sent to the exception handling unit 206. Based on the received message, the exception handling unit 206 determines the exception type about the retiring target, and searches the read-only memory 208 to run the corresponding exception handler (#UD handler or #GP handler). The exception handling unit 206 decodes the code of exception handler into microinstructions and sends them to the renaming unit 216 for execution, to determine whether the abnormal instruction causing the exception is a special instruction monitored in the disclosure or not. If yes, the special instruction is translated.

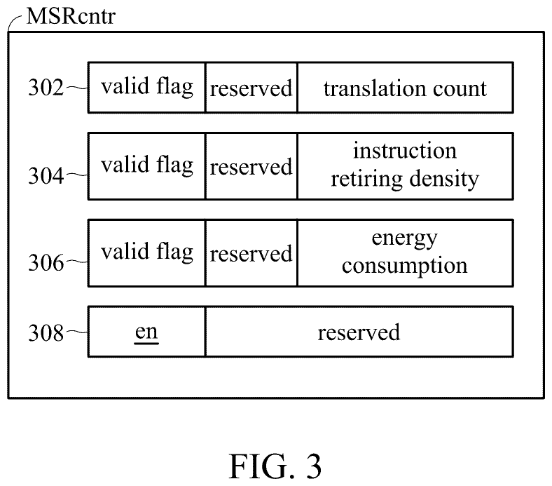

FIG. 3 illustrates a design of the model-specific registers MSRcntr in the core 200 in accordance with an exemplary embodiment of the disclosure, which include model-specific registers (MSRs) 302, 304, 306, and 308.

The core-change indicators (translation count, instruction retiring density, and energy consumption) are directly updated on the MSRs 302, 304, and 306. The MSR 308 stores control information, including an enable field (that may be 1 bit) that is operative to enable/disable using the MSRs 302, 304, and 306 to update the core-change indicators. For example, when the enable field “en” is asserted (e.g., set to 1), the core-change indicator evaluation function is enabled, and the translation count, instruction retiring density, and energy consumption are updated on the MSRs 302, 304, and 306. When the enable field “en” is cleared (e.g., set to 0), the core-change indicator evaluation function is disabled. In another exemplary embodiment, the enable field “en” may be three bits, to separately enable/disable the MSRs 302, 304, and 306, and thereby evaluation of translation count, instruction retiring density, and energy consumption, are enabled/disabled, separately.

The MSR 302 (corresponding to the translation count) stores the number of instructions which have been translated. In response to the asserted setting in the enable field “en” of the MSR 308, the translator ISAtrans_# counts the translated instructions. If a valid flag in the MSR 302 is asserted (for example, set to 1), the translation count recorded in the MSR 302 is valid. When the valid flag in the MSR 302 is cleared (for example, set to 0), the translation count recorded in the MSR is invalid. In an exemplary embodiment, the valid flag and the translation count in the MSR 302 are cleared (for example, set to 0) at the same time. When the translation count function is enabled, the valid flag in the MSR 302 is asserted (for example, set to 1) and the translation count is dynamically updated on the MSR 302. In an exemplary embodiment, the translation count is an accumulated result. For example, the updated translation count is the sum of the previous translation count and the number of the new translated instructions.

The MSR 304 (corresponding to the instruction retiring density) stores the number of clock cycles used to retire instructions. The retiring unit 205 monitors the number of clock cycles of instruction retiring, and this capability is enabled in response to the asserted setting in the enable field “en” of the MSR 308. When the valid flag of the MSR 304 is asserted (for example, set to 1), the instruction retiring density recorded in the MSR 304 is valid. When the valid flag of the MSR 304 is cleared (for example, set to 0), the instruction retiring density recorded in the MSR 304 is invalid. In an exemplary embodiment, the valid flag and the instruction retiring density in the MSR 304 are cleared at the same time (for example, set to 0). When the instruction retiring density evaluation function is enabled, the valid flag of in the MSR 304 is asserted (for example, set to 1), and the information about the instruction retiring density is dynamically updated on the MSR 304. In an exemplary embodiment, the instruction retiring density is presented in an accumulated result of the number of clock cycles used in retiring instructions (e.g., the sum of the previously accumulated number of clock cycles and the number of the newly-added number of clock cycles). In another exemplary embodiment, the instruction retiring density is presented in the number of instructions retired in each clock cycle.

The MSR 306 (corresponding to energy consumption) stores a cache-miss count. A cache (e.g., the instruction cache 212 in FIG. 2) can implement this counting, and the counting capability is enabled in response to the asserted setting in the enable field “en” of the MSR 308. During application execution, if the requested data is not in the cache, a cache miss occurs, and the computer system 100 suspends the execution of the application till the requested data is read from the system memory 104. When being paused, the application consumes less energy. The higher the cache-miss count is, the longer the application is paused, and the lower the energy consumption is. When the valid flag of the MSR 306 is set (for example, set to 1), the energy consumption record in the MSR 306 is valid. When the valid flag of the MSR 306 is cleared (for example, set to 0), the energy consumption record in the MSR 306 is invalid. In an exemplary embodiment, the valid flag and the energy consumption record in the MSR 306 are cleared at the same time (for example, set to 0). When the energy consumption evaluation function is enabled, the valid flag in the MSR 306 are asserted (for example, set to 1), and the information about energy consumption is dynamically updated on the MSR 306. In an exemplary embodiment, the energy consumption is presented as an accumulated result of the cache-miss counts (e.g., the sum of the previously accumulated cache-miss count and the number of the newly-added cache-miss count. In another exemplary embodiment, the energy consumption is presented as the number of clock cycles used in I/O accessing.

Specifically, to run an application, the operating system (OS) creates an application process (i.e., a task), which involves a process-control block (PCB for short). In an exemplary embodiment, when assigning a task (i.e., an application process) to a target core as a target application process, the operating system first clears the MSRs MSRcntr (to clear the previous records about the translation count, instruction retiring density, the energy consumption), and then asserts the enable field “en” of the MSR 308 to start a new round of evaluation about the core-change indicators for the target application process. When the target application process is paused (that is, the target application process changes from the running state to the ready/suspend state), the corresponding target process-control block (PCB) saves the core-change indicators. When the same application process is dispatched for later, the operating system schedules one of the cores (106_# or 108_#, selected according to the core-change indicators saved in the target process-control block) to continue the execution of the target application process. Thus, a proper core is selected adaptive to the target application. In an exemplary embodiment, the MSRs 302, 304, and 306 operate in an accumulation manner. For example, along with the execution of the target application process, the translation count has been accumulated to 10 on the MSR 302 of the target core. As the target core translates and executes another instruction of the target application later, the translation count in the MSR 302 of the target core is updated to 11 (=10+1).

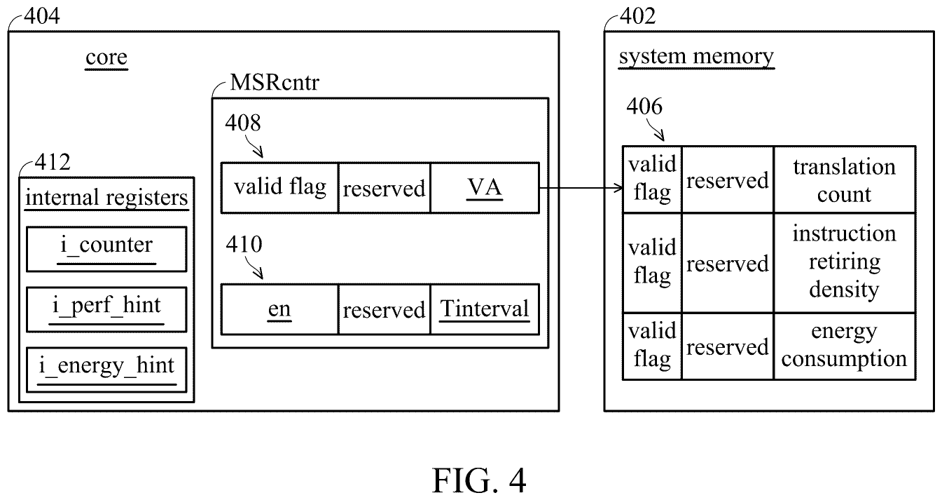

FIG. 4 illustrates a dynamic update manner of the core-change indicators in accordance with another exemplary embodiment of the disclosure. The following discussion is referred to the core-change indicators MEMontr stored in the system memory 104 of FIG. 1.

In the exemplary embodiment shown in FIG. 4, the system memory 402 plans a recording area 406 for each core (404), which has the same functions as the MSRs 302, 304, and 306 of FIG. 3, and is configured to store the translation count, instruction retiring density, and energy consumption. The core 404 may use MSRs 408 and 410 as MSRs MSRcntr. The MSR 408 stores an address VA of the recording area 406 in the system memory 402. The MSR 410 includes the aforementioned enable filed “en” (to enable/disable the evaluation about the core-change indicators), and is programmed to set a time interval Tinterval. The core 404 reads the previous values of translation count, instruction retiring density, and energy consumption from the recording area 406 every time interval Tinterval, and accumulates them with the real-time evaluated translation count i_counter, instruction retiring density i_perf_hint, and energy consumption i_energy_hint in internal register 412. The accumulated result is written back to the recording area 406 of the system memory 402, and the real-time evaluated translation count i_counter, instruction retiring density i_perf_hint, and energy consumption i_energy_hint in the internal register 412 are reset.

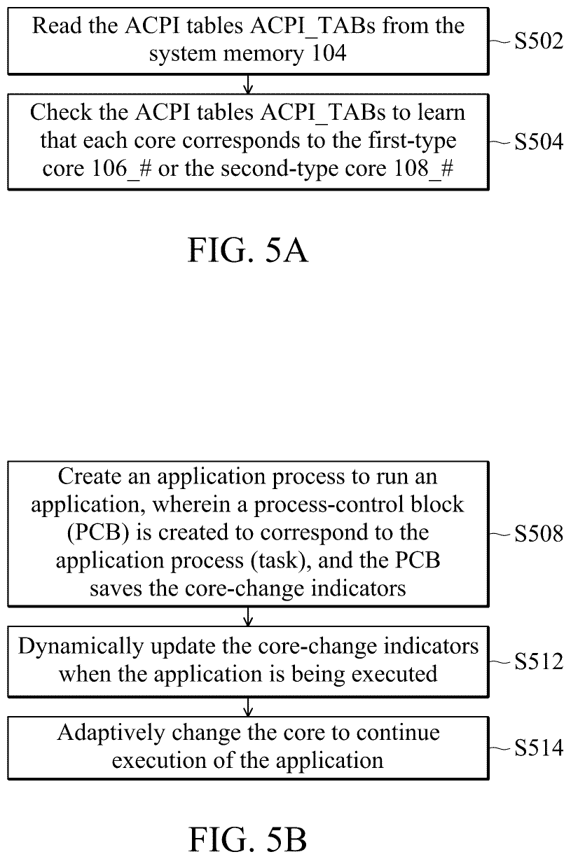

FIGS. 5A and 5B are flow charts illustrating the operations of the operating system in accordance with an exemplary embodiment of the disclosure.

As shown in FIG. 5A, when the computer system 100 starts the operating system, step S502 is executed. In step S502, the computer system 100 reads the ACPI tables ACPI_TABs from the system memory 104. In step S504, the computer system 100 checks the ACPI tables ACPI_TABs to learn that each core corresponds to the first-type core 106_# or the second-type core 108_# and, accordingly, programs core information about each core. For each core, the core type is presented in a processor information structure (cpuinfo) defined by the operating system.

The started operating system executes applications according to the user's request. As shown in FIG. 5B, in step S508, the operating system creates an application process to run an application, wherein a process-control block (PCB) is created to correspond to the application process (task). In the disclosure, the process-control block (PCB) saves core-change indicators (translation count, instruction retiring density, and energy consumption) for the operating system to schedule a proper core to execute the application. In an exemplary embodiment, when creating a new PCB, the operating system initializes the core-change indicators in the newly created PCB (e.g., to zero).

In step S512, when the computer system 100 executes the application process, the retiring unit 205 monitors the instruction retiring density in real time, and writes the obtained instruction retiring density into the process-control block in real time. Furthermore, the cache monitors the energy consumption in real time, and writes the obtained information about energy consumption into the process-control block in real time. During the execution of the application process, the undefined instruction exception handler and the general purpose exception handler dynamically update the translation count into the process-control block. In an exemplary embodiment, the translation count is updated in an accumulated manner. For example, if the translation count is 10, another instruction translation will update the translation count to 11 (=10+1).

In a time-sharing operating system, every fixed time slice (for example, every 10 milliseconds), the operating system pauses the running application process, pushes the paused application process to a ready queue, selects and executes the next application process from the ready queue. In step S514, each time to dispatch a ready application obtained from the ready queue, the operating system adaptively schedules a proper core according to the core-change indicators (the translation count, instruction retiring density, and energy consumption) of the ready application. In an exemplary embodiment, an operating system scheduler assigns the ready application process to the first-type core 106_# or second-type core 108_#(identified by referring to the processor data structure, cpuinfo, of each core) according to the core-change indicators of the ready application process. When the ready application process is executed on the proper core, the translation count, instruction retiring density, and energy consumption is still dynamically updated as described in step S512.

It should be noted that the operating system is also an application and need to be scheduled for execution. However, the developer is familiar to the instructions supported by each core. During programming the operating system, the developer can use the instructions commonly supported by all cores. Thus, execution efficiency of operating system is guaranteed.

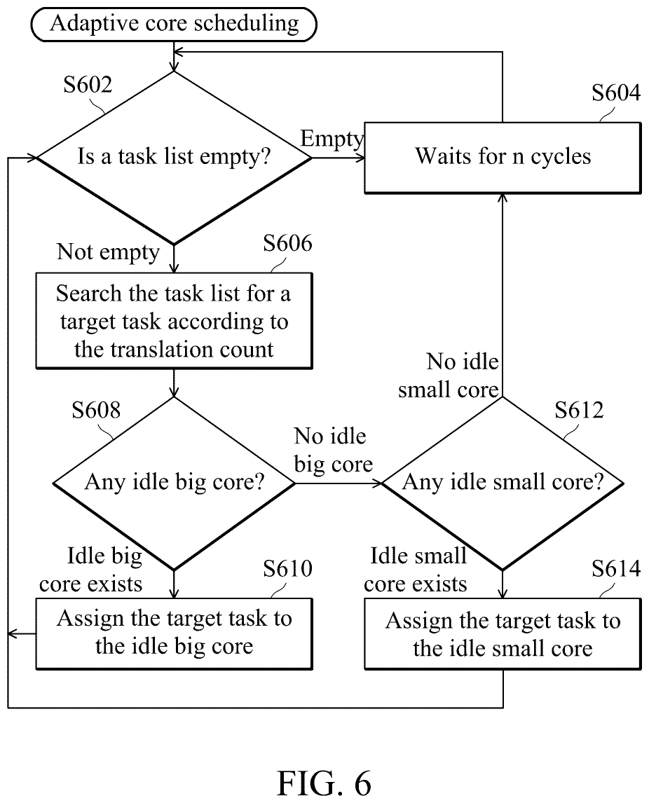

The step S514 of FIG. 5 is further discussed with respect to FIG. 6, which details how the operating system adaptively assigns an application process to a proper core according to the core-change indicators of the application.

FIG. 6 is a flow chart illustrating how the operating system adaptively assigns an application process to a proper core based on a translation count of the application. In an exemplary embodiment, the first-type core 106_# is a small core, and the second-type core 108_# is a big core. The core-change indicator to be checked is the translation count accumulated in the execution of the application.

In step S602, the operating system scheduler determines whether a task list is empty. If yes, step S604 waits for n cycles (i.e., clock cycles) and then checks the task list again (S602). In another exemplary embodiment, when it is determined that the task list is empty, the operating system scheduler enters a sleep state and waits for an interrupt to wake up. When a new task is added to the task list, the operating system scheduler is awakened by an interrupt. For example, when the operating system executes a new application, the operating system creates a new task, adds the newly-created task to the task list, and issues an interrupt to wake up the operating system scheduler.

If it is determined in step S602 that the task list is not empty, step S606 is performed. In step S606, the operating system scheduler searches the task list for a target task according to the translation count, wherein the target task has a translation count that is the highest and greater than a threshold. In an exemplary embodiment, the threshold is 0. In step S608, the operating system scheduler determines whether any big core (second-type core 108_#) is idle. If yes, step S610 is performed. The operating system scheduler assigns the target task to the idle big core (second-type core 108_#) for execution. In an exemplary embodiment, if the selected idle big core is in a sleep state, the current core running the operating system scheduler sends an Inter-Processor Interrupt (IPI) to the selected idle big core to wake it up. Then, the target task is executed by the awakened big core.

If the operating system scheduler determines in step S608 that the big cores (second-type cores 108_#) are all busy, step S612 is performed. The operating system scheduler determines whether there is an idle small core (first-type core 106_#). If the small cores (first-type core 106_#) are all busy, the operating system scheduler waits for n cycles by step S604. On the contrary, in step S614, the operating system scheduler assigns the target task to the idle small core (the first-type core 106_#) for execution. In an exemplary embodiment, the task list is a ready queue managed by the operating system.

In this way, all tasks are appropriately assigned to the different types of cores in the hybrid architecture processor 102.

In an exemplary embodiment, there are tasks 1 and 2 for execution. The translation count T1.counter of task 1 is higher than the translation count T2.counter of task 2. Step S606 selects task 1 as the target task that needs to be executed with priority. If it is determined in step S608 that there is an idle big core, step S610 assigns the idle big core to perform task 1. The process returns to step S602 while task 2 remains in the task list. Then, step S606 selects task 2 as the next target task. If step S608 determines that there is an idle big core, step S610 assigns the task 2 to be executed by the idle big core. If there are no idle big core, but step S612 determines that there is an idle small core, then step S614 is performed. In step S614, the task 2 is executed by the idle small cores. In this way, task 1 (in the more need to be assigned to the big core than task 2) is assigned to the big core with priority. If more than one big core are idle, both tasks 1 and 2 are executed efficiently on the big cores.

The aforementioned core change concept may be applied in the more complex examples. In an exemplary embodiment, the translation count, instruction retiring density, and energy consumption are all considered in the core change mechanism. A task triggering instruction translation on a small core is given the higher priority to be changed to a big core and, at the same time, instruction retiring density and energy consumption may be also taken into consideration in the core change procedure.

In an exemplary embodiment, there are tasks 1 and 2, and their translation count, instruction retiring density, and energy consumption are all considered in the core change procedure. The translation count T1.counter of task 1 is higher than the translation count T2.counter of task 2. In the early stage of operations, task 1 is assigned to the big core in priority over task 2. Later, the information about instruction retiring density and energy consumption collected during operations can trigger the core change event again.

In an exemplary embodiment, for task 1 (T1), the instruction retiring density T1.A_Pcounter observed by core A is better than (e.g., higher than or lower than, depending on the design) the instruction retiring density T1.B_Pcounter observed by core B, and the energy consumption T1.B_Ecounter observed by core B is better than (e.g., higher than or lower than, depending on the design) the energy consumption T1.A_Ecounter observed by core A. If instruction retiring density is in the higher priority in the core change procedure, core A is scheduled to take over task 1. If energy consumption is in the higher priority in the core change procedure, core B is scheduled to take over task 1.

In an exemplary embodiment, the core-change indicators of an application include a first instruction retiring density and a second instruction retiring density. The first instruction retiring density is monitored by the retiring unit (205) of the first-type core 106_#, and the second instruction retiring density is evaluated by the retiring unit (205) of the second-type core 108_#. In response to the second instruction retiring density better than (e.g., higher than or lower than, depending on the design) the first instruction retiring density, the operating system increases the probability of scheduling the second-type core 108_# to run the application.

In an exemplary embodiment, the core-change indicators of an application include first-energy consumption and second-energy consumption. The first-energy consumption is evaluated by the first-type core 106_#, and the second-energy consumption is evaluated by the second-type core 108_#. In response to the second-energy consumption better than (e.g., higher than or lower than, depending on the design) the first-energy consumption, the operating system increases the probability of scheduling the second-type core 108_# to run the application.

The core change concept of this disclosure is further used to implement a method for application compatible execution. The method includes providing a hybrid architecture processor 102 that includes a first-type core 106_# and a second-type core 108_#, wherein in response to execution of an application, through an operating system running on the hybrid architecture processor 102, the method includes evaluating core-change indicators corresponding to the application, to change the core executing the application to another one of the first-type core 106_# and the second-type core 108_# based on the core-change indicators, to continue execution of the application.

There may be various modifications to the details of the aforementioned exemplary embodiments. Any hybrid architecture processor (including the first-type core 106_# and the second-type core 108_#) with the core change mechanism based on core-change indicators (translation count, or/and instruction retiring density, or/and energy consumption) may fall into the scope of protection of the disclosure.

Through the computer system and application compatible execution method proposed in the disclosure, the operating system evaluates core-change indicators of an application, and switches between the first-type core and the second-type core according to the evaluated core-change indicators. Execution of the application fully utilizes the resources of the different cores.

While the disclosure has been described by way of example and in terms of the preferred embodiments, it should be understood that the disclosure is not limited to the disclosed embodiments.

What is claimed is:

1. A computer system, comprising:
a hybrid architecture processor, including a first-type core and a second-type core;
wherein:
in response to execution of an application, an operating system running on the hybrid architecture processor evaluates core-change indicators corresponding to the application, to change core executing the application from the first-type core to the second-type core, or vice versa, based on the core-change indicators, to continue execution of the application.

2. The computer system as claimed in claim 1, wherein:
the operating system creates an application process corresponding to the application, and the application process uses a process-control block to save the core-change indicators; and
based on the core-change indicators saved in the process-control block, the operating system selects the first-type core or the second-type core to continue the execution of the application.

3. The computer system as claimed in claim 2, wherein:
the first-type core and the second-type core each include model-specific registers; and
when a core is running a target application, the core uses its model-specific registers to dynamically update core-change indicators, related to the core, of the target application, which are further saved in a target process-control block of a target application process created for the target application.

4. The computer system as claimed in claim 3, wherein:
the core-change indicators of the target application process are dynamically updated on the model-specific registers of the core currently running the target application.

5. The computer system as claimed in claim 3, further comprising:
a system memory, providing a recording area for each core, for storage of core-change indicators of applications running on the different cores;
wherein:
the model-specific registers of each core store an address pointing to the recording area on the system memory and store a time interval;
each core further includes internal registers, storing information to be updated to the recording area at each time interval, and the information in the internal registers are reset after the information is updated to the recording area at each time interval.

6. The computer system as claimed in claim 1, wherein:
the second-type core supports special instructions that are not supported by the first-type core, or that are supported by the first-type core with changed semantics.

7. The computer system as claimed in claim 1, wherein:
the first-type core includes a translator which is configured to translate the special instructions for execution on the first-type core;
the core-change indicators of the application include a translation count; and
in response to the translation count being increased, the operating system increases a probability of switching to the second-type core to run the application.

8. The computer system as claimed in claim 1, wherein:
the core-change indicators of the application include a first instruction retiring density and a second instruction retiring density;
the first instruction retiring density is monitored by a retiring unit of the first-type core, and the second instruction retiring density is monitored by a retiring unit of the second-type core; and
in response to the second instruction retiring density being higher than the first instruction retiring density, the operating system increases a probability of switching to the second-type core to run the application.

9. The computer system as claimed in claim 1, wherein:
the core-change indicators of the application include first-energy consumption and second-energy consumption;
the first-energy consumption is evaluated by the first-type core, and the second-energy consumption is evaluated by the second-type core; and
in response to the second-energy consumption being lower than the first-energy consumption, the operating system increases a probability of switching to the second-type core to run the application.

10. The computer system as claimed in claim 9, wherein:
the first-energy consumption is evaluated from a cache-miss count about a cache memory of the first-type core; and
the second-energy consumption is evaluated from a cache-miss count about a cache memory of the second-type core.

11. The computer system as claimed in claim 9, wherein:
the first-energy consumption is evaluated from accumulated number of clock cycles of input and output instructions of the first-type core; and
the second-energy consumption is evaluated from accumulated number of clock cycles of input and output instructions of the second-type core.

12. A method for application compatible execution, comprising:
providing a hybrid architecture processor that includes a first-type core and a second-type core; and
in response to execution of an application, through an operating system running on the hybrid architecture processor, evaluating core-change indicators corresponding to the application, to change core executing the application from the first-type core to the second-type core, or vice versa, based on the core-change indicators, to continue execution of the application.

13. The method as claimed in claim 12, wherein:
the operating system creates an application process corresponding to the application, and the application process uses a process-control block to save the core-change indicators; and
based on the core-change indicators saved in the process-control block, the operating system selects the first-type core or the second-type core to continue the execution of the application.

14. The method as claimed in claim 13, wherein:
the first-type core and the second-type core each include model-specific registers; and
when a core is running a target application, the core uses its model-specific registers to dynamically update core-change indicators, related to the core, of the target application, which are further saved in a target process-control block of a target application process created for the target application.

15. The method as claimed in claim 14, wherein:
the core-change indicators of the target application process are dynamically updated on the model-specific registers of the core currently running the target application.

16. The method as claimed in claim 14, further comprising:
for each core, providing a recording area on a system memory, for storage of core-change indicators of applications running on the different cores;
wherein:
the model-specific registers of each core store an address pointing to the recording area on the system memory and store a time interval;
each core further includes internal registers, storing information to be updated to the recording area at each time interval, and the information in the internal registers are reset after the information is updated to the recording area at each time interval.

17. The method as claimed in claim 12, wherein:
the second-type core supports special instructions that are not supported by the first-type core, or that are supported by the first-type core with changed semantics.

18. The method as claimed in claim 12, wherein:
the first-type core includes a translator which is configured to translate the special instructions for execution on the first-type core;
the core-change indicators of the application include a translation count; and
in response to the translation count being increased, the operating system increases a probability of switching to the second-type core to run the application.

19. The method as claimed in claim 12, wherein:
the core-change indicators of the application include a first instruction retiring density and a second instruction retiring density;
the first instruction retiring density is monitored by a retiring unit of the first-type core, and the second instruction retiring density is monitored by a retiring unit of the second-type core; and
in response to the second instruction retiring density being higher than the first instruction retiring density, the operating system increases a probability of switching to the second-type core to run the application.

20. The method as claimed in claim 12, wherein:
the core-change indicators of the application include first-energy consumption and second-energy consumption;
the first-energy consumption is evaluated by the first-type core, and the second-energy consumption is evaluated by the second-type core; and
in response to the second-energy consumption being lower than the first-energy consumption, the operating system increases a probability of switching to the second-type core to run the application.

21. The method as claimed in claim 20, wherein:
the first-energy consumption is evaluated from a cache-miss count about a cache memory of the first-type core; and
the second-energy consumption is evaluated from a cache-miss count about a cache memory of the second-type core.

22. The method as claimed in claim 20, wherein:
the first-energy consumption is evaluated from accumulated number of clock cycles of input and output instructions of the first-type core; and
the second-energy consumption is evaluated from accumulated number of clock cycles of input and output instructions of the second-type core.
